(19) United States
(12) Patent Application Publication
(10) Pub. No.: US 2010/0050074 A1
(43) Pub. Date: Feb. 25, 2010

(54) CONTEXT SENSITIVE, ERROR CORRECTION OF SHORT TEXT MESSAGES

(75) Inventors: Nahi Nachmani, Tel Aviv (IL); Sarid Smadar, Tel Aviv (IL); Dror Zernik, Haifa (IL)

Correspondence Address: ROBERT G. LEV, 4766 MICHIGAN BLVD., YOUNGSTOWN, OH, 44505, US

(73) Assignee: Cellesense Technologies Ltd., Tel Aviv (IL)

(21) Appl. No.: 12/312,200

(22) PCT Filed: Oct. 28, 2007
(86) PCT No.: PCT/IL07/01308

§ 371 Date: Apr. 28, 2009

Related U.S. Application Data
(60) Provisional application No. 60/855,152, filed on Oct. 30, 2006.

(51) Int. Cl. G06F 17/24; G06F 17/27; G06F 17/21

(52) U.S. Cl. 715/257; 715/259

(57) ABSTRACT

A method for correcting a short text message comprising the steps of: creating a table of common words and misspellings; identifying keypad used for sending the message, examining message for comprehensibility; identifying most likely error, substituting symbols based on a hierarchical system of shared keys followed by adjacent keys to hypothesize correction of the most likely error; examining hypothesized correction for comprehensibility, and repeating steps (c) to (f) until an understandable message is generated.

### FIELD OF THE INVENTION

The present disclosure relates to a method and system for correcting electronically transmitted text. More particularly, the invention relates to text messaging commonly known as SMS or Texting and Instant Messaging interfaces.

### BACKGROUND OF THE INVENTION

Text Messaging, known in Europe as ‘SMS’ and in the United States as ‘Texting’ using the letter entry facility of the numeric keypad of cellular phone is widely used for communication, particularly for interacting with automatic services. There is a need to process Text messages such as textual requests, and to respond in an appropriate way, either with a service operation, or a reply message.

The user interfaces of mobile phones are, however, extremely limited and not ideal for text messaging. Only a small number of buttons, a tiny display and highly restricted computing capabilities are available. Nevertheless, Instant Messaging has become a dominant communication mechanism.

The advantage of SMSing and Instant Messaging is the ease of its generation and the availability of cellular devices. The text often has extremely poor quality. Apart from the inherent limitations of the cellular keypad, often text messages are written while the user is engaged in a different, more demanding activity. Accordingly, in order to provide automatic text-based services there is a substantial need to analyze and correct errors in both the input device (while typing the message) and on the receiver side—correcting the input message.

Since wrong keystrokes are common, predictive text software may be used on the sender side (the phones, or the Instant Messaging terminal) to provide some word-selection and word completion facilities, and T9 has become a de-facto standard for cell-phones. Predictive-text software reduces the number of key-strokes required per word, and the number of spelling mistakes. However, it may introduce new types of errors. Spell checkers in the Windows environment (such as common for PDAs, and Instant Messaging), often suggest incorrect replacements. This is relevant in particular in the presence of multiple errors.

Error correction and prevention—takes place on the input device side. The most common technology for reducing the number of errors and for improving the ease of inputting a text message over the phone is the predictive-text software, such as T9. Predictive-text combines the groups of letters marked on each phone key with a fast-access dictionary of words, and recognizes a set of possible pre-defined words to the text the user has typed. Predictive-text offers the most commonly-used word for every key sequence the user enters by default and then lets the user:

Access other choices from the set of possible words for the typing,

Define an alternative word, hence, the ability to extend the dictionary, for future use in the same set,

The ability to turn off the predictive-text service.

The ability to insert a specific word that is not part of the dictionary (a street name, a person surname or a stock name)

The predictive-text dictionary on the phone includes a common set of words, however many words such as people's names, domain dependant names and the like, do not appear in the phone dictionary.

The dictionary is limited due to the following reasons:
1. Commonality—the dictionary must reflect the common words used in each language.
2. Space/memory limitation in the phone
3. Constantly changing data is complex/expensive to load onto the phone.
4. Generality—the dictionary should be relevant for all the services, that is, it is hard to assume that a special-purpose dictionary will be used for each unique service: e.g. telephone directory service, bus schedule service, and stock rate service—have to use the same general purpose dictionary.

Similarly, in a Windows-like environment, spell checkers and predictive text can both be used, but also have a limited scope. (For example, predictive text is used almost only for days and months, and spell checking allows for one-letter errors or letter crossing).

From this short discussion it is obvious that while a general-purpose Predictive-text, as a sample word-completion/word-selection method reduces the number of simple spelling errors, and improves the usability of SMSing, it does not prevent other errors, and can introduce new types of errors.

The following documents are incorporated herein by reference:

[1] T9© 2006 Tegic Communications, Inc. All Rights Reserved. T9 is a registered trademark of Tegic Communications, Inc. http://www.t9.com/

[2] Using Levinstein Distance—U.S. Pat. No. 6,073,099—Predicting auditory confusions using a weighted Levinstein distance

[3] Hamming Distance and Levinstein Distance—Error Correction Coding: Mathematical Methods and Algorithms, by Todd K. Moon. Wiley Publishers. ISBN: 0-471-73914-6.

[4] Error correction for QWERTY—patent of the QWERTY—structure—http://en.wikipedia.org/wiki/Christopher_Sholes (1868

[5] Parsing with errors—Compilers: Principles, Techniques, and Tools, Aho, Sethi and Ullman, ISBN 0-201-10088-6

[6] U.S. Pat. No. 4,754,474—Interpretive tone telecommunication method and apparatus.

### SUMMARY OF THE INVENTION

The invention relates to a system and method for automatic correcting of errors such as spelling errors, grammatical errors, poor syntax and the like, in the text of electronic textual message such as an SMS or Instant Message. As with prior art word completion and word selection software, software in accordance with the present invention may be used on the sender equipment on the message generating side (the cellular phone, PDA or computer terminal). In some embodiments, software of the invention may be effectively deployed on the server or on the receiver side. In a first aspect, the present invention is directed to a method for correcting a short text message comprising the steps of: (a) creating a table of common words and misspellings; (b) identifying keypad used for sending the message; (c) examining message for comprehensibility; (d) identifying most likely error; (e) substituting symbols based on a hierarchical system of shared keys followed by adjacent keys to hypothesize correction of the most likely error; (f) examining hypothesized correction for comprehensibility, and (g) repeating steps c to f until an understandable message is generated.

Optionally the method is run by sender hardware prior to sending.

The method may comprise the additional step of offering the understandable message to sender for authorization.

The sender hardware may be selected from the list of PDAs and mobile phones.

Alternatively, the method may be run by the receiver system.

Optionally, the message sent further comprises a code for informing the receiver hardware of the keypad used for sending the message.

Preferably, the receiver system is programmed to relate to a limited vocabulary and the receiver system matches words in the message with words in the vocabulary.

Preferably, the matching of words in message with words in the vocabulary is sensitive to the sending keypad.

Preferably, the receiver system is programmed to relate to a limited grammar and syntax and the receiver system matches the message with the limited grammar and syntax.

Preferably, the matching of words in message with words in the vocabulary is sensitive to the sending keypad.

Optionally, the step of identifying the most likely error comprises the step of checking the message for common spelling mistakes and correcting.

Optionally, the step of identifying the most likely error comprises comparing words of the message with phonetic equivalents.

Optionally, the method utilizes Levinstein distances between symbols.

Alternatively, the method utilizes Hammer distances between symbols.

A second aspect of the invention is directed to a system for correcting a short text message comprising a list of symbols sharing common keys of transmitting keypad used to transmit the short text message and a means of identifying errors in the short text message.

Preferably the system further comprises a vocabulary supported by the receiver system.

Preferably the system further comprises a series of grammar rules for parsing the short text message.

Preferably the system further comprises a database of phonetic equivalents.

Preferably the system further comprises a database of common typos.

### BRIEF DESCRIPTION OF FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a flow chart of the method in accordance with an embodiment of the invention and

FIG. 2 is a functional block diagram of the system of the invention.

### DETAILED DESCRIPTION OF PREFERRED IMPLEMENTATION

Predictive-text and spell checking by themselves are not sufficient for allowing a server, on the receiving side, to automatically process the text messages, and an additional layer of error correction must be constructed. The reason is simple, the complete sentence must be parsed, and a meaningful result must be gained. This is, by the nature of the service a context sensitive task, and therefore, a general purpose correction is inaccurate.

The text written by the end user may be improved by the local software (word prediction or spell checker) and is then transmitted to the server, which, upon receiving the text, must parse it (tag each word), to reconstruct the desired semantics. Before, or during the parsing process, errors are detected, and then corrected.

Embodiments of the current invention relate to an automatic error correction method that is aware of the input device and of the application, namely, the type of service. The method may be applied on the server side, or installed on the client side if it is designed as a “special purpose” device for the service. The method takes into account the errors that still commonly occur in text messages. These errors are created with the predictive-text and spell correction programs, or by users who do not use such software (e.g. in the cases where the predictive text software dictionary lacks the required words). The new error correction method further takes into account the influence on the frequency of errors as a result of using different input devices, e.g. for messages that are generated from a computer keyboard, or on a PDA, or on a cell phone.

The required error correction, in order to support automated services, are referred to as ‘server-side’ as this is the preferred implementation. The error correction on the server side should provide a method for automatically and accurately correcting the transmitted text. Further, the method must relate to several specific use cases:

A. The case that predictive-text software is used on the transmitter side. Predictive-text usage does not eliminate errors:

a. If the user does not know how to correctly spell a word, he might type a close enough spelling, and then may get “a close enough” word.

b. The user may erroneously accept a wrong alternative from the set of words. This is especially common if the first and the last letters of the suggested erroneous word are identical to the desired word.

c. The user may use a word from the predictive-text dictionary that the user himself/herself has previously typed in, using an incorrect spelling. This is especially common for words that the user does not succeed in correctly spelling in the first case.

B. The case in which the predictive-text software is turned off since the dictionary does not contain a specific word or simply because the user prefers to type text in the conventional way.

C. With predictive-text turned off, the probability of typos increases, as the user must press on each key the right amount of times to get the intended letter. Further, if the user is used to using T9, by turning the application off, the habits may introduce more errors.

D. The case where a standard, computer keyboard is used.

E. The more general case where an alternative error prevention method is used.

Thus in a simple preferred embodiment, the invention is a software program that runs on a server, gets a text written on a phone keypad with or without predictive text and spell checking such as T9 help. The software then searches for and fixes possible errors in the input message. The software can also utilize a variety of additional Natural Language Processing techniques to analyze the text as a whole and not on a word-by-word base thus it is able to find and fix more mistakes and overcome ambiguities.

One of the foundations of error correction is a distance function. It is natural to assume that the likelihood of a “close distance” error is bigger than of a “larger distance” error. That is, while typing, one can easily replace the word “word” by the word “work”. If one knows that the input device is a cellular phone then it is obvious that the word “work” is closer to the word “York” then to the word “word”, simply because the W and Y letters share the same key. Similarly, when using a keyboard, one may easily replace the word “word” by the word “wrod”. Hence, error correction tries to replace a close, similar word by a “more fitting” word. In conventional text correction methods the distance is typically defined by the number of letters that need to be replaced. As we will see, when word completion and word correction are operating, new distance functions must be considered. Further, semantics and complete parsing of the message may be required in order to indicate about the possible existence of an error.

The invention may comprise multiple stages of error correction:

Pre-processing Stage 1: Define a mapping method from any input word into an abstract representation. (A string derived from the input device properties or the phonetic properties or both). The ability of this mapping to be device sensitive is a core contribution of the invention.

Pre-processing Stage 2: Define a domain specific dictionary and preferences. (Typically, proper nouns and professional verbs: e.g. city names, for transportation services, stock triples or quadruples for stock service, etc')

Pre-processing Stage 3: Define a grammar of “service messages” which is an extension of the common language, and is domain specific: e.g. the following pattern is a legal message for a transportation application:

P1={optional <date or day of the week>} {optional “from”} <CITY-1> {optional “to”} <CITY-2>.

(This pattern stands for sentences of the form:

1. Sunday from Washington to New-York.

2. From Washington to New-York and

3. Washington to New York.)

Pre-processing Stage 4: Define a distance function for each transformation: including both word level and pattern level correction distance. This distance function can be a weighted combination of errors within a word, and errors which allow for transformation from one complete sentence. Service Stage: On receiving a message, during the parsing process, locate a global optimum: a parsing of the input, which minimizes the total distance to an acceptable correct parsing.

For the sake of simplicity, using the T9 example in the sequel:

A. Define a Keypad Representation:

A keypad representation of a token is created by replacing all characters in the token using the following key:

| Letters | Key |
|---|---|
| A, B, C | 2 |
| D, E, F | 3 |
| G, H, I | 4 |
| J, K, L | 5 |
| M, N, O | 6 |
| P, Q, R, S | 7 |
| T, U, V | 8 |
| W, X, Y, Z | 9 |

For example: the word “apple” is converted to “27753”. Note that this is not a one-to-one function. Many words can be mapped into any given single number (for example: “home”, “good”, “hood”, “gone”, “hoof”, “hone”, “goof” . . . all map to “4663”).

In embodiments of the present invention, once the mapping is defined, a domain specific dictionary is used. Each word in the dictionary is mapped into its proper keypad representation, and the reverse function is constructed: hence from each number all the relevant words can be constructed.

An incoming text message is processed by software of the invention. It is broken to tokens and each token is searched in an existing relevant possible word list. If the word is found in the word list then no mistake is identified, however if the word cannot be (that is the number representation of the word cannot be mapped back into a word from the dictionary) then the software tries to find an alternative word.

Given an error word, or an error in parsing such that the meaning of the message as a whole is not acceptable, software of the invention tries to locate the closest possible alternative for correction purposes. This stage is geared to determine the best approximate word(s), doing this by measuring the editing distance between the original token from the input text and the list of possible words, for the closest possible parsing pattern. A good example for a way to measure the editing distance may be “Levinstein Distance” algorithm. (The Levinstein distance is typically the number of letters that need to be replaced/insert/delete in order to get from word “A” to word “B”, which is more relevant for error correction in this context than the Hamming Distance).

Given the keyboard representation, software of the invention can apply correction in several ways. These are possible sample implementations:

1. Use the keyboard representation function for finding all the possible alternatives. This allows for improving the distance function.

2. Use domain specific word-preferences—for example, in a sporting service, the word “base” is more likely to be used than the word “case” or the word “care”. T9 software would typically choose “case”, as in the general dictionary this is more commonly used.

3. Augment the list with standard “dictionary” errors—e.g. replacing “i” and “e” when they are consecutive; adding/removing duplicate letters (leter→letter); using phonetic similarity (then→than), etc'.

While building the keyboard representation, one can also take into account the physical distance of keys:

| | | |
|---|---|---|
| 1 | 2 | 3 |
| 4 | 5 | 6 |
| 7 | 8 | 9 |
| | 0 | |

The user is most likely to make an error between 7 and 8, then between 7 and 4. The likelihood of replacing a 7 by a 5 or a 3 is significantly lower.

All of the above define the mapping functions and the distance between errors for a specific word. Hence, these are all physical device improvements for the distance function which defines error probability.

This function is applied also to the extended dictionary, which contains domain specific words as well. Obviously, domain specific dictionary is more naturally implemented on the server side.

Note that an incorrect parsing may be received even when all the words are perfectly correct. Further, for a specific service, a correct (English, or any other language), cannot be parsed, as it cannot be handled to generate any of the service actions. For example—the question “What is the weather in New-York?”—is a perfect English sentence, but the train-oriented service is not necessarily designed to answer weather related questions. Further, the general language grammar may allow, even for relevant requests that could be handled by the server, had it been capable of correctly parsing the pattern. For example, in the same train service example, an acceptable pattern may be:

{Optional time-question} P1 {optional “?”}.

(Assuming that P1 is as defined earlier). If the token or pattern <time-question> is defined, this pattern then could be matched with anything that P1 would accept, with the option of adding a relevant question word before the pattern. E.g. “When is the next train from Washington to New York?”.

Now imagine a request of the form: “Washington to New York when is the next train?”

If the grammar does not contain an appropriate pattern, the system will fail to parse it.

A global error correction may fix this by providing a distance function between patterns. It is not reasonable to assume that order changing within a pattern can always be added as a rule. For example, in a directory service application (such as 411 in the US), one can require that the accepted pattern should be:

<Last-name>”,37 <First-name>”,“<City>

In this case, it is not reasonable to allow order changing, as the message:

“Bill, Clinton, Washington”—cannot be reordered. Even when an error is detected in one of the names, and “local” error correction may indicate that re-shuffling the names may yield an acceptable parsing.

In the cases where the parsing failed error correction can be applied. It first tries to reach possible parsing by correcting erroneous words, and then, if necessary, or if no erroneous word exists, it tries to replace words with same keyboard representation, to reach the closest parsing pattern.

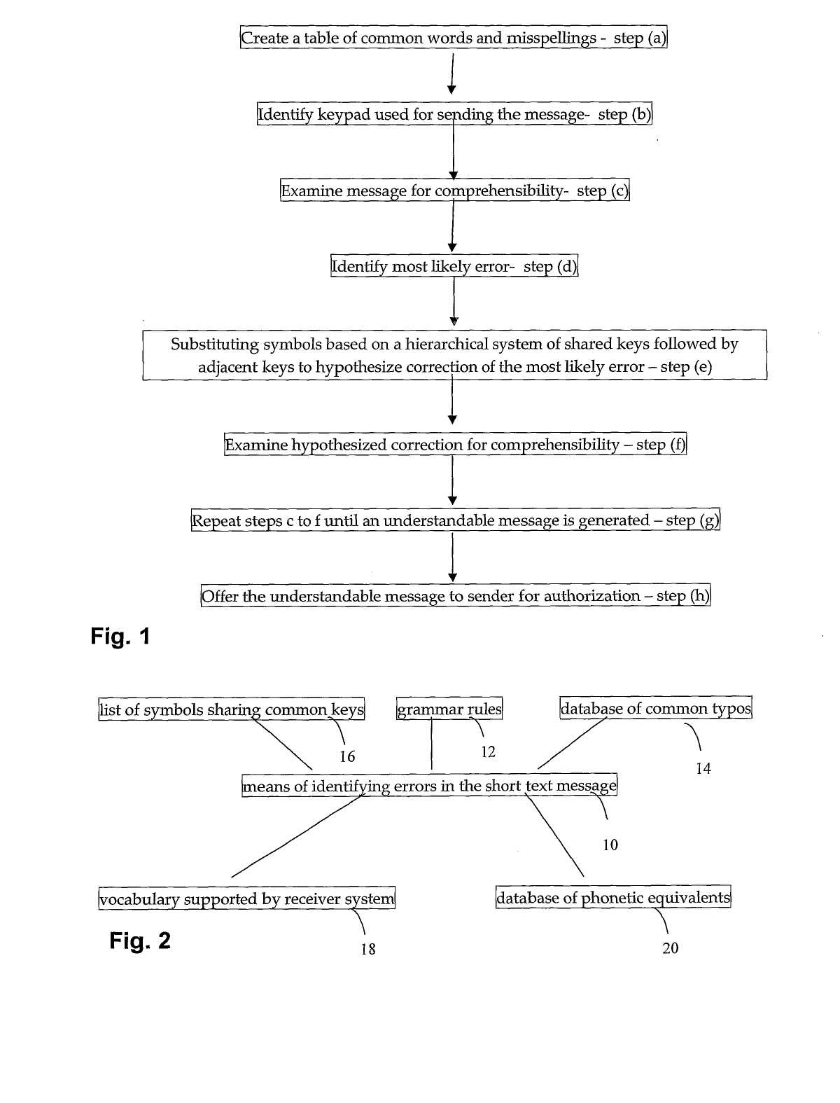

With reference to FIG. 1, the present invention is directed to a method of for correcting a short text message comprising the steps of: creating a table of common words and misspellings—step (a); identifying keypad used for sending the message—step (b); examining the message for comprehensibility—step (c); identifying the most likely error—step (d); substituting symbols based on a hierarchical system of shared keys followed by adjacent keys to hypothesize correction of the most likely error—step (e); examining hypothesized correction for comprehensibility—step (f); and repeating steps c to f until an understandable message is generated.

The method may be run by sender hardware prior to sending. Optionally, the method comprises the additional of offering the understandable message to sender for authorization—step (h).

With reference to FIG. 2, a system for correcting a short text message in accordance with one embodiment of the invention is shown. The system includes a means of identifying errors in the short text message 10, a series of grammar rules 12 for parsing the short text message, a database of common typos 14, a list of symbols sharing common keys of transmitting keypad used to transmit the short text message 16, a vocabulary supported by the receiver system 18 and a database of phonetic equivalents 20.

Thus the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A method for correcting a short text message comprising the steps of:
a. Creating a table of common words and misspellings;
b. Identifying keypad used for sending the message,
c. Examining message for comprehensibility;
d. identifying most likely error,
e. substituting symbols based on a hierarchical system of shared keys followed by adjacent keys to hypothesize correction of the most likely error;
f. Examining hypothesized correction for comprehensibility, and
g. Repeating steps c to f until an understandable message is generated.

2. The method of claim 1 being run by sender hardware prior to sending.

3. The method of claim 2 comprising additional step h of offering the understandable message to sender for authorization.

4. The method of claim 2 wherein the sender hardware is selected from the list of PDAs and mobile phones.

5. The method of claim 1 being run by receiver system.

6. The method of claim 5 wherein the message sent further comprises a code for informing the receiver hardware of the keypad used for sending the message.

7. The method of claim 6 wherein the receiver system is programmed to relate to a limited vocabulary and the receiver system matches words in the message with words in the vocabulary.

8. The method of claim 7 wherein the matching of words in message with words in the vocabulary is sensitive to the sending keypad.

9. The method of claim 6 wherein the receiver system is programmed to relate to a limited grammar and syntax and the receiver system matches the message with the limited grammar and syntax.

10. The method of claim 7 wherein the matching of words in message with words in the vocabulary is sensitive to the sending keypad.

11. The method of claim 1 the step of identifying the most likely error comprises the step of checking the message for common spelling mistakes and correcting.

12. The method of claim 1 wherein the step of identifying the most likely error comprises comparing words of the message with phonetic equivalents.

13. The method of claim 1 utilizing Levinstein distances between symbols.

14. The method of claim 1 utilizing Hammer distances between symbols.

15. A system for correcting a short text message comprising a list of symbols sharing common keys of transmitting keypad used to transmit the short text message and a means of identifying errors in the short text message.

16. The system of claim 15 further comprising a vocabulary supported by the receiver system.

17. The system of claim 15 further comprising a series of grammar rules for parsing the short text message.

18. The system of claim 15 further comprising a database of phonetic equivalents.

19. The system of claim 15 further comprising a database of common typos.

20. The system of claim 15 for implementing the method of claim 1.
